(19) United States
(12) Patent Application Publication
(10) Pub. No.: US 2008/0280978 A1
(43) Pub. Date: Nov. 13, 2008

(54) Insect Repellent Compositions

(76) Inventors: Bernard Zeelie, Port Elizabeth (ZA); Ilse Asquith, Port Elizabeth (ZA); Shawn Gouws, Port Elizabeth (ZA); Jacques Vandenschrik, Port Elizabeth (ZA)

Correspondence Address: Ronald R. Santucci;c/o Frommer Lawrence & Haug LLP, 745 Fifth Avenue, New York, NY, 10151, US

(21) Appl. No.: 11/596,772

(22) PCT Filed: May 20, 2005
(86) PCT No.: PCT/IB2005/001373

§ 371 Date: Apr. 8, 2008

(30) Foreign Application Priority Data
May 20, 2004 (ZA) 2004/3914

(51) Int. Cl. A01N 37/10; A01P 17/00

(52) U.S. Cl. 514/532

(57) ABSTRACT

An insect repellent composition containing 3,8-p-menthane-diol and benzylbenzoate as active compounds is described. Typically, the active compounds are each present in the composition in an amount which is less than an amount of the compound required to be effective as an insect repellent by itself. The composition may additionally include one or more additional active compounds selected from the group consisting of 2-butyl-2-ethyl-1,3-propanediol, 2-ethyl-1,3hexanediol and 5-N-butylacetanilide. One or more promoters, carriers, diluents, dispersants, solvents, emollients, emulsifiers, colouring agents, fragrances or thickening agents may also be included in the composition.

### BACKGROUND OF THE INVENTION

The invention describes an insect repellent composition.

Biting insects such as mosquitoes, ticks, horse flies, the common housefly and the like carry a variety of diseases, for example malaria, yellow fever, West Nile virus, Borreliosis (lyme disease) and tick-borne encephalitis.

According to statistics from the World Health Organization, one person is killed by complications arising from these diseases approximately every thirty seconds globally. Indeed, one death in seventeen in the world is purportedly caused by a mosquito bite. Malaria alone is responsible for approximately three million deaths every year. Mosquitoes transmit the arboviruses responsible for yellow fever, dengue, hemorrhagic fever, epidemic polyarthritis, and several forms of encephalitis. Bancroftian filariasis is caused by a nematode transmitted by mosquito bite.

Protection from biting by insects has the advantage of providing protection against a variety of different insects, and hence protection from transfer of disease. The application of natural, strong-smelling natural substances to the human skin in order to repel mosquitoes and other biting insects dates back to ancient Egypt. There are also references to the use of substances such as camphor, cypress, galbanum, lupin and cinnamon as insect repellents in ancient Roman literature.

The use of insect repellents is now the method of choice amongst consumers to protect themselves from the dangers of insect bites. As a result, insect repellent products have developed into an important sector of the consumer health market—not only because they are effective, but also because they are affordable. The main disadvantages of such products, however, are that they often only provide protection for limited time periods, requiring repeated application, and that active compounds, despite the use of fragrance materials, are often irritating to individuals. Alternative methods of protection, such as vaccination and preventative medication, while highly effective in specific cases, are costly and are also only specific to any one type of disease.

All modern repellent products contain an active ingredient, one or more solvents and in most cases, a fragrance material to mask the unpleasant smell of the active compound. After application to the skin or other surfaces such as clothes and walls, the solvents in the repellent evaporate, leaving a protective layer that interferes with the normal “scent” of the body. The repellent is effective for only as long as it takes for the active compound in the repellent to evaporate or to be removed by other mechanisms such as washing and sweating. Most active compounds in insect repellents are high-boiling liquid compounds with boiling points above 150° C.

Since its first appearance in consumer products, following its discovery during the Second World War, N,N-diethyl-3-methylbenzamide (DEET) (formerly known as N,N-diethyl-m-toluamide) has been regarded as the most effective compound to use in topical insect repellent formulations. Depending on the concentration at which it is applied, it can provide between 2 and 8 hours of protection against mosquitoes, flies and ticks. However, despite its effectiveness, DEET suffers from a number of disadvantages, namely:
It has a high potential to irritate eyes and mucous membranes.
It has a sticky, greasy skin feel and a strong, long-lasting odour which lead to instinctive rejection of these products by many consumers.
DEET-containing products are not recommended for continuous use, or for use on infant skin, being suspected of causing medical conditions such as meningitis.
DEET has a strong solvent and plasticiser effect on many plastic items and lacquered surfaces and can cause severe damage to items such as spectacles, watches and synthetic materials used in clothing or accessories.

Alternative, non-DEET repellents can be divided into two groups, i.e. chemical (synthetic) and natural (plant derived). The main synthetic active compounds are dimethyl phthalate (and derivatives thereof) and 1-piperidinecarboxylic acid, 2-(2-hydroxyethyl)-, 1-methylpropylester. The first of these compounds, while still being found in some insect repellent products, is a suspected carcinogen and may be mutagenic. The second compound, also known as Bayrepel™, is a relatively new active compound and compares well with DEET in terms of effectiveness, but suffers fewer disadvantages. It is only found in Autan™ products by Bayer.

Natural products most commonly used include citronella oil and soybean-oil. Since these “actives” are natural, they are believed to be safer than synthetic active compounds, but their widespread use and lack of quality control in many such products may negate this advantage. Furthermore, some of the formulated products containing these natural materials that have been tested under rigorous laboratory conditions have shown that claims of their effectiveness are severely overrated. In most cases, such products:
will work for disappointingly short periods of time (usually less than 1.5 hours);
will provide protection against some insects only;
will not protect against very aggressive insects, in particular mosquitoes; and
have to be used in such high concentrations that they can be even more irritating than their synthetic counterparts.

The applicant has therefore identified a need to develop an insect repellent that overcomes some, most or all of the disadvantages of known insect repellents. In particular, there is a need for an insect repellent which has the following properties:
effectiveness: must provide substantially “all-day” protection;
safety: must contain only non-toxic substances and must contain the lowest possible level of active compounds; and
consumer-friendly: must have little or no irritation, must be colourless, and must have an acceptable odour.

### SUMMARY OF THE INVENTION

According to a first aspect of the invention there is provided an insect repellent composition including 3,8-p-menthane-diol and benzylbenzoate as active compounds.

The 3,8-p-menthane-diol and benzylbenzoate may each be present in the composition in an amount which is less than an amount of the compound required for it to be effective as an insect repellent by itself.

The composition may further include one or more active compounds selected from the group consisting of 2-butyl-2-ethyl-1,3-propanediol, 2-ethyl-1,3hexanediol and 5-N-butylacetanilide. For example, the composition may include 3,8-p-menthane-diol, benzylbenzoate and 5-N-butylacetanilide as active compounds, the amount of each active compound being insufficient for that active compound to act as an insect repellent on its own.

The composition may also include one or more promoters, carriers, diluents, dispersants, solvents, emollients, anti-oxidants, emulsifiers, anti-oxidants, colouring agents, fragrances or thickening agents.

The promoter may be a compound derived from a para-alkoxybenzaldehyde structure, such as vanillin or ethyl vanillin. Alternatively, the promoter may be a compound derived from a 1,2-methylenedioxybenzene structure, such as piperine or piperonyl butoxide.

The carrier may be selected from slow-release media such as liposomes, polymers, latex lattice micro spheres, cyclodextrans, modified celluloses, surfactants and various forms of microencapsulation of the active compounds, and combinations thereof.

The composition may be in a liquid form such as a lotion, mousse, milk, spray or aerosol; or may be in a solid or semi-solid form such as a stick, serum, cream, gel or candle.

The active compounds in the composition may constitute from about 1 to about 60% by mass of the composition, and more particularly from about 1 to about 25% by mass of the composition.

The fraction of 3,8-p-menthane-diol in the composition may be greater than or equal to about 0.01 by mass and the fraction of benzylbenzoate in the composition may be greater than or equal to about 0.06.

### DETAILED DESCRIPTION OF THE PREFERRED EMBODIMENTS

The invention describes an insect repellent composition including at least two active compounds, being 3,8-p-menthane-diol and benzylbenzoate. The composition optionally includes one or more active compounds selected from the group consisting of 2-butyl-2-ethyl-1,3-propanediol, 2-ethyl-1,3hexanediol and 5-N-butylacetanilide.

The applicant studied the occurrence of synergism and/or antagonism amongst a wide variety of known insect repellent active compounds using advanced statistical experimental design methodologies with the view to determining combinations of active substances that, when used in combination, are capable of providing efficient protection against biting insects at total active loadings which are significantly lower than loadings found in existing consumer products. The advantages of lowering the total active loadings in consumer products, whilst retaining or even improving the overall efficacy of said products, include improved affordability, improved consumer safety, improved consumer acceptance of products and the ability to formulate products previously not possible.

Initially, numerous compounds were identified for their individual activity in insect repellent compounds. Many of the compounds so identified were eliminated from further study due to health and safety considerations and concerns over consistent availability. Compounds that were selected for further testing were combined in various combinations as a lotion and tested singly and in combination with other compounds for efficacy in preventing mosquito bites. The results of these screening experiments were used to identify and quantify synergism between active compounds, and compounds so identified were again subjected to statistically designed mixture experiments to determine optimum ratios, at specific total active loadings, of individual components in a synergistic mixture.

Thus, the applicant has found that highly efficient insect repellent compositions may be prepared using a combination of two or more specific insect repellent compounds that act synergistically upon each other. The active compounds include 3,8-p-menthane-diol and benzylbenzoate, and additional optional active compounds which may be added to the composition include 2-butyl-2-ethyl-1,3-propanediol, 2-ethyl-1,3hexanediol and 5-N-butylacetanilide. A composition including the combination of 3,8-p-menthane-diol, 2-butyl-2-ethyl-1,3-propanediol and benzylbenzoate is a particularly preferred combination.

The total amount of active substance (i.e. the active compounds in combination with each other) in any particular repellent composition is not restricted and may be in the range of from about 0.5-60% by mass, particularly in the range of from about 1-25% by mass. The total active compound loading may be manipulated depending on the type of carrier system being used and also depending on the length of desired protection time required. For example, sun creams for recreational use may contain a lower loading of active compounds than a lotion or aerosol designed specifically for long protection periods.

The ratios of the individual active compounds that are added together to form the composition are important in determining the efficacy of the composition and the protection time any particular composition provides. The protection time provided by a specific composition at a constant mass loading may be altered by varying the ratio of active compounds added to the mixture. A person skilled in the art will realise that it is not feasible to give a precise description of the lower and upper bounds for individual compounds in various compositions. However, without intending to limit the scope of the invention, in one embodiment of the invention, the lower limits of 3,8-p-menthane-diol and benzylbenzoate in the composition are as follows (given that the sum of the fractions in the final active mixture is one (1)): fraction of 3,8-p-menthane-diol≧0.3; fraction of benzylbenzoate≧0.06. In other embodiments, the fraction of 3,8-p-menthane-diol is only about 0.02 Or 0.05.

Apart from the individual synergistic active compounds, the insect repellent composition may also contain one or more promoters, i.e. substances that have no insect repellent activity themselves, but which enhance the activity of one or more of the individual active compounds in the final composition. In some cases, the use of promoters has the additional advantage that they act as fragrance materials. A number of promoters were identified that, when used in conjunction with the active compounds, substantially enhance the efficacy of the end product. Two groups of compounds, in particular, are preferred as effective promoters for enhancing the efficacy of synergistic mixtures of repellent active compounds, i.e. (i) compounds based on and derived from a para-alkoxybenzaldehyde structure (4-ROC₆H₄CHO); and (ii) compounds based on and derived from a 1,2-methylenedioxybenzene (C₆H₄O₂CH₂) structure.

Promoters of the first type are preferred for use in compositions intended for human contact, such as topical applications. The basic structure is preferably modified by altering the length of the R-group in the alkoxy moiety, with chain lengths of 1-8 carbon or other atoms being preferred. Such R-groups may either be linear or branched and saturated or unsaturated, and may contain cyclic moieties. It is additionally preferred to include at least one additional carbon or other chain, R′, into the aromatic ring, such group or groups being preferably in the 3 and 5 positions on the ring. The R′-group preferably has 1-8 carbon or other atoms and either linear or branched and saturated or unsaturated chains which may also contain cyclic moieties may be used. Promoters of the first type with chain lengths of 1 to 5 carbon or other atoms on both R and R′ are preferred, such compounds comprising 0.001% to 3%, and preferably 0.01% to 2% of the final product in mass. Specific examples of this group of promoters are vanillin and ethyl vanillin.

Promoters of the second type are preferred for compositions intended for application to physical structures or products intended for vaporization. The basic 1,2-methylenedioxybenzene structure is preferably modified by including two groups in positions 4 (R) and 5 (R′) of the ring. Either of R or R′ is preferably, but not limited to, a —CH₂OH group with the other being either a straight or branched, saturated or unsaturated, cyclic or non-cyclic, chain of between 1 and 8 carbon or other atoms. The —CH₂OH group is preferably further modified by forming either esters or ethers through the alcohol moiety. Specific examples of this group of promoters are piperine and piperonyl butoxide.

The repellent products could comprise many different forms, depending upon the desired target delivery site. Delivery sites could be any one or more of the following: surfaces such as on skin, clothing or other materials, physical structures such as walls, ceilings, floors and the like, and even a defined ambient space.

For skin, topical or other surface applications, the composition could include a solid, semi-solid or liquid carrier which should be cosmetically and/or pharmaceutically acceptable for topical use.

The term “carrier” as used herein refers to a substance which acts as a diluent, dispersant or solvent for the repellent active compound, thereby ensuring that the active compound can be applied to and distributed evenly over the selected target in a suitable amount and at an appropriate concentration.

The carrier can itself be inert or can possess particular benefits of its own. For example, moisturizing properties may be desirable in topical formulations. Topical application is preferably achieved with compositions in the forms of lotions, solutions, ointments, serums, sprays, tonics, creams, bars, cream rinses, gels, sticks, mousses, pastes and the like. Such repellent compositions may be formulated for use in conjunction with an applicator such as a roll-ball applicator, a pad applicator, a spray device such as an aerosol can containing propellant, a container fitted with a pump to dispense the liquid product, or a liquid-impregnated fabric, such as a tissue wipe. Alternatively, the compositions can be solid or semi-solid, for example, sticks, serums, creams or gels. Such solid or semi-solid compositions may be formulated for use in conjunction with a suitable applicator or simply a tube, jar or other convenient container. Persons skilled in the art will therefore realise that the selection of the carrier will depend on the required product form of the composition.

Carriers for surface application include water and cosmetically- and/or pharmaceutically-acceptable carriers other than water. The carrier is preferably one which can aid the distribution and retention of the repellent active compounds over the skin or surface, from where it can evaporate slowly into the surrounding atmosphere to act as an insect repellent. Carriers useful in topical and surface application compositions according to the invention include slow-release media such as liposomes, polymers, latex lattice micro spheres, cyclodextrans, modified celluloses, surfactants and various forms of microencapsulation of the active compounds. A preferred amount of slow release agent is from about 1% to about 5% of the composition.

Generally, the carrier is either aqueous or organic in nature or may be an aqueous emulsion, and is capable of having the repellent active compounds dispersed or dissolved therein. The carrier may include cosmetically- and/or pharmaceutically-acceptable emollients, colouring agents, fragrances, emulsifiers, thickening agents and/or solvents.

Topical compositions of the present invention may be formulated as a composition comprising an emollient. Such compositions typically comprise from about 1% to about 50%, preferably from about 5% to about 20% of a topical cosmetically- and/or pharmaceutically-acceptable emollient; and an effective amount of the repellent active.

As used herein, the term “emollients” refers to materials used for the prevention or relief of dryness, as well as for the protection of the skin. A wide variety of suitable emollients is known and may be used herein. Suitable emollients include, but are not limited to, hydrocarbon oils and waxes, silicone oils, triglyceride fats and oils, acetoglyceride esters, ethoxylated glycerides, alkyl esters of fatty acids having 10 to 20 carbon atoms, alkenyl esters of fatty acids having 10 to 20 carbon atoms, fatty acids having 8-22 carbon atoms, fatty alcohols having 2-22 carbon atoms, fatty alcohol ethers, ether-esters, anoline and derivatives, polyhydric alcohols and their polyether derivatives, wax esters, beeswax derivatives, vegetable waxes, phospholipids, sterols, and amides. SAGARIN, COSMETICS, SCIENCE AND TECHNOLOGY, 2nd Edition, Vol. 1, pp. 3243 (1972), incorporated herein by reference, describes numerous examples of suitable emollient materials.

Anti-oxidants may also be included in compositions for topical administration. While any suitable anti-oxidant can be used, a particular example is Vitamin E or a salt thereof, such as Vitamin E acetate.

Topical compositions of the present invention may also be formulated as a cream. Preferably the cream will include an effective amount of the active compounds; from about 5% to about 50%, preferably from about 10% to about 25%, of an emollient; and from about 25% to about 95% water. Optionally, the cream may contain a suitable emulsifier. When an emulsifier is included, it will typically form from about 3% to about 50%, preferably from about 5% to about 20% of the composition. Emulsifiers may be nonionic, anionic or cationic. Suitable emulsifiers are disclosed in, for example, U.S. Pat. No. 3,755,560, issued Aug. 28, 1973, Dickert et al.; U.S. Pat. No. 4,421,769, issued Dec. 20, 1983, Dixon et al.; and McCutcheon's Detergents and Emulsifiers, North American Edition, pp. 317-324 (1986); the disclosures of which are incorporated herein by reference. Preferred emulsifiers are anionic or nonionic.

Topical compositions may also be formulated as a lotion. Preferably, the lotion will include an effective amount of the active compounds; from about 1% to about 50%, preferably from about 3% to about 15% of an emollient; and from about 45% to about 85%, preferably from about 50% to about 75% water. Optionally, the lotion form may contain a suitable emulsifier, comprising from about 3% to about 50%, preferably from about 10% to about 20% of the final composition. Suitable emulsifiers are those described above in relation to cream formulations.

Preferably, a solution form of the invention includes an effective amount of the repellent active compounds, water and/or a suitable organic solvent. Suitable organic solvents are: propylene glycol, glycerin polyethylene glycol (M.W. 200-600), polypropylene glycol (M.W. 425-2025), sorbitol esters, 1,2,6-hexanetriol ethanol, isopropanol, diethyl tartrate, butanediol, and mixtures thereof. For surface applications other than for topical applications, solutions may optionally contain surfactants, wetting agents and slow release media as described above for carriers.

Gel compositions of the present invention can be formulated by mixing a suitable thickening agent with the previously described solution compositions. The gel compositions preferably comprise an effective amount of the repellent active compounds; from about 5% to about 75%, preferably from about 10% to about 50%, of an organic solvent as previously described for solutions; and from about 0.5% to about 20%, preferably from about 1% to about 10% of the thickening agent.

Repellent products can be formulated in a variety of different solid forms for different purposes. Stick-type compositions can be formulated for application to the skin. Such compositions preferably include an effective amount of the repellent active compounds, and from about 50% to about 98%, preferably from about 60% to about 90%, of the previously described emollients. Such compositions can further comprise from about 1% to about 20%, preferably from about 5% to about 15%, of a suitable thickening agent, and optionally emulsifiers and water.

Solid products may also be formulated using combustible materials such as waxes and oils to form candles that release vapours into the surrounding atmosphere while burning. Such compositions preferably contain an effective amount of the insect repellent active compounds, and from 50% to 98%, preferably from about 65% to 95% of suitable candle wax. Such compositions can further contain from about 1% to 20%, preferably from about 2% to 10% of combustible natural plant oil and optionally fragrance materials and colourants.

Solid products may also be formulated so as to release active vapours by indirect heating, for example by means of an electric vaporising device. Such products may either be formulated in their own containers, ready for placement on the vaporising device, or formulated as a refill for existing containers. Such compositions preferably contain an effective amount of insect repellent active compounds, and from 10% to 90% water, preferably from 30% to 80% water, and from 5% to 50% emulsifiers, preferably 10% to 40%. Depending on the nature of the individual active compounds used, such products may further contain from 0.1% to 5%, preferably from 0.5% to 3% organic solvent as described above for solutions.

Various other solid products may also be formulated such that the composition, upon exposure to the atmosphere, releases active vapours over a sustained period to repel or prevent insects entering the space where such composition is present. Such compositions preferably include an aesthetically acceptable distribution device, as for example in a basket of dried leaves or petals, over which a solution of the composition may be sprinkled from time to time. Alternatively, said distribution device may be constructed so as to release active compound vapours slowly over a period of time without the option to replenish the composition.

### EXAMPLES

Embodiments of the insect repellent composition of the present invention are illustrated below by means of a number of illustrative examples, which are not to be construed as limiting the scope of the present invention in any manner whatsoever.

### Example 1

### Topical Applications

### Efficacy Testing Procedures

In accordance with the relevant method in section 4 of SABS Method 807, yellow fever (Aedes aegypti) mosquitoes, approximately 7-14 days old, were deprived of a blood meal for >96 hours and used as the test insects. The following equipment was also used for the insect repellence tests:
Wooden test cages 300 mm high, 300 mm wide, 450 mm long and sides covered with nylon mosquito netting, one side having a sleeve-inlet.
Plastic tubes 200 cm³ with a diameter of ±60 mm and height ±80 mm and covered with nylon mosquito netting on both ends.

The wooden test cages were prepared 24 hours before commencement of the repellency test and contained 100 mosquitoes. The plastic tube containing 30 mosquitoes was prepared an hour before the test. As a food source, cotton wool was soaked in a 5% sugar solution and placed inside the test cages and plastic tubes.

Volunteers' forearms were washed thoroughly with unscented soap and water to remove any traces of perfume. As a control to determine if the mosquitoes and arms used for the test were normal, one arm, chosen at random, of each volunteer was placed inside a wooden cage containing 100 mosquitoes. Once 10 mosquitoes had landed, the time was recorded and the arm withdrawn from the cage. The norm used is that at least 10 landings should be recorded within a 30 second period. The hand of the volunteer was covered with a latex glove during the control test.

Each volunteer's forearm was divided into three by drawing a line with a pen at the borders of each area. These areas were treated liberally with a numbered sample. The areas were treated as follows: starting with the left arm closest to the hand with the one next to it second and so on with the last treatment closest to the right hand. After a fifteen-minute wait, either a plastic tube was placed on the treated area or the arm was exposed to the test cage for a five-minute period, respectively. The number of bites obtained during the five-minute period was recorded, and only those treated areas where five or less bites were recorded, were re-exposed hourly, for up to 5 hours.

For each treatment evaluated, a score was calculated based upon the total number of bites received by the test subject over the test period. In cases where the test was terminated prior to the specified period being completed, an arbitrary high number (15) was allocated to each time period after termination of the test. The results of these tests are reflected in Table 1 below, the scores reflecting the efficacy of each mixture, with a low score being desirable.

In Table 1, 3,8-p-menthane-diol (A), 2-butyl-2-ethyl-1,3-propanediol (B), 2-ethyl-1,3hexanediol (C), benzylbenzoate (D) and the carrier comprise a mixture of emulsifying oils (30% by mass), phenoxy ethanol (1% by mass) and water (69% by mass).

### Example 2

### Topical Applications Including a Promoter

Four samples were prepared using a consistent ratio of compounds A:B:D (0.05:0.025:0.025 fraction by mass) together with a carrier (fraction by mass=0.899) comprising the carrier of example 1 (samples 4 and 6 in Table 2) or an 80:20 mixture of ethanol:water (samples 3 and 5) and a promoter substance (vanillin: 0.001 by mass for samples 5 and 6). These samples were compared against two DEET containing samples (samples 1 and 2) (DEET fraction=0.15 by mass) using either the carrier of example one (sample 2) or an 80:20 mixture of ethanol:water (sample 1).

Table 2 reflects the results of efficacy tests carried out on samples comprising modified carriers and a promoter substance, and is compared directly with a sample containing N,N-diethyl-3-methylbenzamide (DEET) for comparative purposes. No scores were calculated and the number of bites received at each exposure is reflected directly.

### Example 3

### Vaporizing Tests

A sample was prepared according to the data given in Table 3 below and said formulation was used as a vaporizer. The sample was tested for efficacy using a method based on section 5 of SABS SM 695 and using a catalytic vaporizing device (Lampe Berger).

TABLE 1
Results of Efficacy Testing

| Run | Score | A | C | D | B | Carrier |
|---|---|---|---|---|---|---|
| 1 | 31 | 6.25% | 1.25% | 1.25% | 1.25% | 90% |
| | | (3.1109 g) | (0.626 g) | (0.6291 g) | (0.6276 g) | (44.7321 g) |
| 2 | 272 | 0 | 0 | 10% | 0 | 90% |
| | | | | (5.0096 g) | | (44.6462 g) |
| 3 | 138 | 0 | 5% | 5% | 0 | 90% |
| | | | (2.4631 g) | (2.5349) | | (44.7443 g) |
| 4 | 64 | 3.33% | 0 | 3.33% | 3.33% | 90% |
| | | (1.6602 g) | | (1.6617 g) | (1.6575 g) | (44.752 g) |
| 5 | 29 | 5% | 0 | 0 | 5% | 90% |
| | | (2.5109 g) | | | (2.4905 g) | (45.2769 g) |
| 6 | 102 | 5% | 0 | 0 | 5% | 90% |
| | | (2.5057 g) | | | (2.4905 g) | (45.2769 g) |
| 7 | 123 | 3.33% | 3.33% | 0 | 3.33% | 90% |
| | | (1.6521 g) | (1.657 g) | | (1.6499 g) | (46.3701 g) |
| 8 | 174 | 0 | 10% | 0 | 0 | 90% |
| | | | (5.0114 g) | | | (45.0589 g) |
| 9 | 296 | 0 | 0 | 10% | 0 | 90% |
| | | | | (5.0114 g) | | (45.0589 g) |
| 10 | 89 | 0 | 0 | 5% | 5% | 90% |
| | | | | (2.4922 g) | (2.4693 g) | (46.725 g) |
| 11 | 126 | 0 | 5% | 0 | 5% | 90% |
| | | | (2.5012 g) | | (2.4878 g) | (46.725 g) |
| 12 | 184 | 0 | 3.33% | 3.33% | 3.33% | 90% |
| | | | (1.6819 g) | (1.6779 g) | (1.6631 g) | (43.9579 g) |
| 13 | 99 | 2.5% | 2.5% | 2.5% | 2.5% | 90% |
| | | (1.2615 g) | (1.2672 g) | (1.2631 g) | (1.2513 g) | (44.5637 g) |
| 14 | 131 | 3.33% | 3.33% | 3.33% | 0 | 90% |
| | | (1.6600 g) | (1.6557 g) | (1.6573 g) | | (45.2657 g) |
| 15 | 141 | 1.25% | 6.25% | 1.25% | 1.25% | 90% |
| | | (0.6400 g) | (3.1194 g) | (0.6296 g) | (0.6311 g) | (45.4848 g) |
| 16 | 70 | 5% | 5% | 0 | 0 | 90% |
| | | (2.5013 g) | (2.4220 g) | | | (44.5782 g) |
| 17 | 84 | 0 | 0 | 0 | 10% | 90% |
| | | | | | (5.0080 g) | (45.4720 g) |
| 18 | 101 | 1.25% | 1.25% | 6.25% | 1.25% | 90% |
| | | (0.6334 g) | (0.6265 g) | (3.1420 g) | (0.6217 g) | (44.749 g) |
| 19 | 151 | 0 | 10% | 0 | 0 | 90% |
| | | | (5.0181 g) | | | (45.4232 g) |
| 20 | 37 | 5% | 0 | 5% | 0 | 90% |
| | | (2.5595 g) | | (2.5066 g) | | (44.7134 g) |
| 21 | 68 | 1.25% | 1.25% | 1.25% | 6.25% | 90% |
| | | (0.6351 g) | (0.6365 g) | (0.6292 g) | (3.122 g) | (46.0702 g) |
| 22 | 43 | 10% | 0 | 0 | 0 | 90% |
| | | (5.0108 g) | | | | (44.6734 g) |
| 23 | 57 | 0 | 0 | 0 | 10% | 90% |
| | | | | | (4.9636 g) | (45.2340 g) |
| 24 | 75 | 10% | 0 | 0 | 0 | 90% |
| | | (4.9967 g) | | | | (44.8796 g) |

A = 3,8-p-menthane-diol
B = 2-butyl-2-ethyl-1,3-propanediol
C = 2-ethyl-1,3hexanediol
D = benzylbenzoate

TABLE 2
Results of efficacy tests

| | Hours after treatment and total number of bites | | | | | |
|---|---|---|---|---|---|---|
| | inflicted | | | | | |
| Sample number | 1 | 2 | 3 | 4 | 5 | 6 |
| (contents) | hrs | hrs | hrs | hrs | hrs | hrs |
| 1 (DEET solution) | 0 | 0 | 0 | 1 | 2 | 3 |
| 2 (DEET lotion) | 0 | 0 | 0 | 0 | 5 | |
| 3 (solution) | 2 | 2 | 0 | 3 | | |
| 4 (lotion) | 3 | 3 | | | | |
| 5 (promoted, | 0 | 0 | 0 | 0 | 4 | 1 |
| solution) | | | | | | |
| 6 (promoted, | 0 | 1 | 1 | 4 | | |
| lotion) | | | | | | |

TABLE 3
Vaporizer formulation

| Component | Fraction (by mass) |
|---|---|
| Isopropyl alcohol | 0.85 |
| Water | 0.12 |
| 3,8-p-menthanediol | 0.02 |
| Benzyl benzoate | 0.004 |
| 2-butyl-2-ethyl-1,3-propanediol | 0.004 |
| Vanillin | 0.001 |
| Vitamin E Acetate | 0.001 |

The mosquitoes were released in the side of the Olfactometer where the “polluted” air would be blown in (side X). The wick of the lamp was lit and allowed to burn for one minute, the flame extinguished and the liquid allowed to vaporize. Air was blown into the Olfactometer at a rate of 15 L/min, the temporary partition between the two sides of the Olfactometer removed and the number of mosquitoes on the “unpolluted” side counted every 15 minutes for a period of one hour.

The above test was repeated, but releasing the mosquitoes on the “unpolluted” side and the number of mosquitoes on the polluted side determined every 15 minutes for a period of one hour.

The results obtained from this test are summarized in Table 4.

TABLE 4
Vaporizer results

| | | Number of | |
|---|---|---|---|
| Side on which | | mosquitoes on the | Mean number of |
| repellent-containing | | side where | mosquitoes |
| air was blown in | | unpolluted air was | on side where |
| (indicated as | Period | blown in (Total | unpolluted air |
| Mosquito side or | lapsed | number of | was blown |
| Vacant side) | (minutes) | mosquitoes = 30) | in (out of 30) |
| Mosquito-side | 15 | 22 | 22 |
| | 30 | 22 | |
| | 45 | 22 | |
| | 60 | 22 | |
| Vacant side | 15 | 28 | 27 |
| | 30 | 27 | |
| | 45 | 26 | |
| | 60 | 26 | |

Compositions according to the present invention are advantageous over existing insect repellent compositions in that they are longer-lasting, contain substantially less total active compound loading and are not irritating in smell or skin-feel.

1-22. (canceled)

23. An insect repellent composition including 3,8-p-menthane-diol, benzylbenzoate and one or more additional compounds selected from the group consisting of 2-butyl-2-ethyl-1,3-propanediol, 2-ethyl-1,3hexanediol and 5-N-butylacetanilide as active compounds.

24. A composition according to claim 23, wherein the 3,8-p-menthane-diol and benzylbenzoate are each present in the composition in an amount which is less than an amount of the compound required to be effective as an insect repellent by itself.

25. A composition according to claim 23, which includes 3,8-p-menthane-diol, benzylbenzoate and 5-N-butylacetanilide as active compounds.

26. A composition according to claim 23, wherein the amount of each active compound is insufficient for that active compound to act as an insect repellent on its own.

27. A composition according to claim 23, which includes one or more promoter.

28. A composition according to claim 27, wherein the promoter is a compound derived from a para-alkoxybenzaldehyde structure.

29. A composition according to claim 27, wherein the promoter is vanillin.

30. A composition according to claim 27, wherein the promoter is ethyl vanillin.

31. A composition according to claim 27, wherein the promoter is a compound derived from a 1,2-methylenedioxybenzene structure.

32. A composition according to claim 31, wherein the promoter is piperine.

33. A composition according to claim 31, wherein the promoter is piperonyl butoxide.

34. A composition according to claim 23, which includes one or more carriers that aid in the retention of the active compounds on a surface to which the composition is applied.

35. A composition according to claim 34, wherein the carrier is a combination of polymers and surfactants.

36. A composition according to claim 23, which includes one or more diluents, dispersants, solvents, emollients, emulsifiers, colouring agents, fragrances or thickening agents.

37. A composition according to claim 23, which is in a liquid form.

38. A composition according to claim 37, which is in the form of a lotion, mousse, milk, spray or aerosol.

39. A composition according to claim 23, which is in a solid or semi-solid form.

40. A composition according to claim 23, wherein the active compounds in the composition constitute from about 1 to about 60% by mass of the composition.

41. A composition according to claim 40, wherein the active compounds in the composition constitute from about 1 to about 25% by mass of the composition.

42. A composition according to claim 23, wherein the fraction of 3,8-p-menthane-diol in the composition is greater than or equal to about 0.01 by mass and the fraction of benzylbenzoate in the composition is greater than or equal to about 0.06.
